(19) United States
(12) Patent Application Publication
(10) Pub. No.: US 2024/0351477 A1
(43) Pub. Date: Oct. 24, 2024

(54) HEATING CIRCUIT OF POWER BATTERY AND ELECTRIC VEHICLE

(71) Applicant: BYD COMPANY LIMITED, SHENZHEN, GUANGDONG (CN)

(72) Inventors: Ke ZHANG, Shenzhen (CN); Jiannian LI, Shenzhen (CN); Rongfang WU, Shenzhen (CN); Zizhu GUO, Shenzhen (CN); Yi PAN, Shenzhen (CN)

(21) Appl. No.: 18/759,652

(22) Filed: Jun. 28, 2024

Related U.S. Application Data
(63) Continuation of application No. PCT/CN2022/137555, filed on Dec. 8, 2022.

(30) Foreign Application Priority Data
Jan. 29, 2022 (CN) 202210112694.2

(51) Int. Cl. B60L 58/27; B60L 15/02; B60L 58/18; H02J 7/00

(52) U.S. Cl. CPC B60L 58/27; B60L 15/02; B60L 58/18; H02J 7/0013

(57) ABSTRACT

A heating circuit of a power battery is provided. The power battery includes a first battery core group and a second battery core group connected in series. The heating circuit includes an inverter, an alternating current motor, and a first controller. A neutral point of the alternating current motor is connected to a first connection point between the first battery core group and the second battery core group. The first controller is configured to input a driving signal to control the inverter to alternately connect the first battery core group to the alternating current motor and the second battery core group to the alternating current motor, to cause the first battery core group and the second battery core group to charge each other.

### CROSS-REFERENCE TO RELATED APPLICATIONS

This application is a continuation application of International Patent Application No. PCT/CN2022/137555, filed on Dec. 8, 2022, which is based on and claims priority to and benefits of Chinese Patent Application No. 202210112694.2, filed on Jan. 29, 2022. The entire content of all of the above-referenced applications is incorporated herein by reference.

### FIELD

The present disclosure relates to the vehicle technologies, and more particularly, to a heating circuit of a power battery and an electric vehicle.

### BACKGROUND

With the development of vehicle technologies, vehicles using power batteries as power sources have become increasingly popular. Characteristics of the power batteries are significantly affected by an ambient temperature. Particularly, in a low temperature environment, energy and power characteristics of lithium ion power batteries are severely attenuated. Therefore, the batteries need to be heated in the low temperature environment. How to improve heating performance of self-heating a battery core using an excitation current has become a critical issue.

### SUMMARY

Embodiments of the present disclosure provide a heating circuit of a power battery, to improve heating performance.

According to a first aspect of the present disclosure, a heating circuit of a power battery is provided. The power battery includes a first battery core group and a second battery core group connected in series. The heating circuit includes an inverter, an alternating current motor, and a first controller. A neutral point of the alternating current motor is connected to a first connection point between the first battery core group and the second battery core group. The first controller is configured to input a driving signal to control the inverter to alternately connect the first battery core group to the alternating current motor and the second battery core group to the alternating current motor, to cause the first battery core group and the second battery core group to charge each other.

In an embodiment, a switch is connected in series between the neutral point of the alternating current motor and the first connection point. The heating circuit further includes a second controller, and the second controller is configured to control the switch to turn on or off.

In an embodiment, a protection circuit is connected in series between the neutral point of the alternating current motor and the first connection point.

In an embodiment, a battery capacity of the first battery core group is the same as a battery capacity of the second battery core group.

In an embodiment, the first controller is further configured to adjust the driving signal, to cause an average current intensity value of the first battery core group to be in a range from 1C to 5C and an average current intensity value of the second battery core group to be in a range from 1 C to 5 C, within a first time period.

In an embodiment, the first controller is further configured to adjust the driving signal, to cause that a real-time current of the first battery core group is switched from a positive cycle to a negative cycle to be in a range from 1 to 1000 times within 1 second and that a real-time current of the second battery core group is switched from a positive cycle to a negative cycle to be in a range from 1 to 1000 times within 1 second.

In an embodiment, the first controller is further configured to adjust the driving signal, to cause that a real-time current of the first battery core group is switched from a positive cycle to a negative cycle to be in a range from 1 to 100 times within 1 second and that a real-time current of the second battery core group is switched from a positive cycle to a negative cycle to be in a range from 1 to 100 times within 1 second.

In an embodiment, the first controller is further configured to adjust the driving signal, to cause that a real-time current of the first battery core group is switched from a positive cycle to a negative cycle to be up to 10 times within 1 second and that a real-time current of the second battery core group is switched from a positive cycle to a negative cycle to be up to 10 times within 1 second.

In an embodiment, the first controller is further configured to adjust the driving signal, to cause a magnitude of a real-time current of the first battery core group to be the same as a magnitude of a real-time current of the second battery core group.

In an embodiment, the first controller is further configured to adjust the driving signal, to cause a target ratio to be greater than or equal to 0.3. The target ratio is a ratio of a first value to a second value, the first value is a smaller one of a real-time current absolute value of the first battery core group and a real-time current absolute value of the second battery core group, and the second value is a larger one of the real-time current absolute value of the first battery core group and the real-time current absolute value of the second battery core group.

In an embodiment, the first controller is configured to adjust the driving signal by adjusting a duty cycle and/or a frequency of the driving signal.

According to a second aspect of the present disclosure, an electric vehicle is provided. The electric vehicle includes a power battery and the heating circuit according to any one in the first aspect.

According to the heating circuit of the power battery and the electric vehicle provided in the embodiments of the present disclosure, a circuit is added based on an original circuit topology structure of the electric vehicle. The circuit is from the neutral point of the alternating current motor to the connection point between the first battery core group and the second battery core group, and heating performance can be improved as a whole by using the heating circuit.

Through detailed description of the embodiments of this specification with reference to the accompanying drawings, features, and advantages of the embodiments of this specification will become clear.

### BRIEF DESCRIPTION OF THE DRAWINGS

The accompanying drawings, which are incorporated into this specification and constitute a part of this specification, illustrate embodiments of this specification and, together with this specification, serve to explain the principles of the embodiments of this specification.

FIG. 1 is a block diagram of a heating circuit of a power battery according to an embodiment of the present disclosure;

FIG. 2 is a circuit diagram of a heating circuit of a power battery according to an embodiment of the present disclosure;

FIG. 3 is a schematic diagram of impact of a magnitude of an excitation current on a power battery capacity;

FIG. 4 is a schematic diagram of impact of a frequency of an excitation current on a temperature rise rate; and

FIG. 5 to FIG. 8 are schematic diagrams of decomposition of an impedance spectroscopy of a power battery in different SOCs under the action of excitation currents of different frequencies.

### DETAILED DESCRIPTION

The following describes in detail various embodiments of this specification with reference to the accompanying drawings.

In fact, the following descriptions of at least one embodiment are merely illustrative, and do not constitute any limitation on the embodiments of this specification and application or use of this specification.

It should be noted that: similar reference signs or letters in the accompanying drawings indicate similar items. Therefore, once an item is defined in one accompanying drawing, the item does not need to be further discussed in the subsequent accompanying drawings.

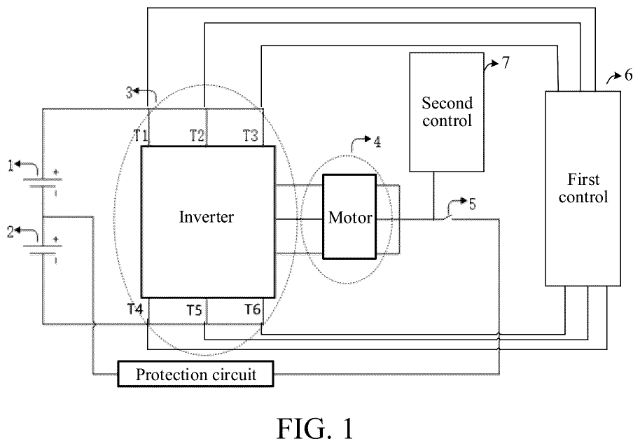

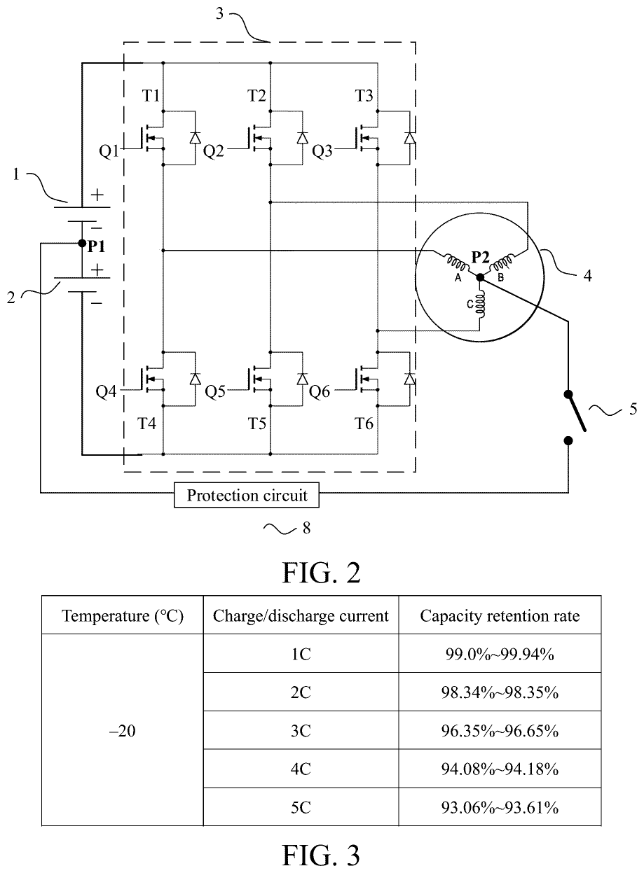

In an electric vehicle, an inverter is connected between a power battery and an alternating current motor. One of main functions of the inverter is to convert a direct current outputted by the power battery into an alternating current to drive the alternating current motor to rotate, so as to drive a wheel to rotate. A power battery heating solution in the embodiments of the present disclosure utilizes a circuit topology structure between the power battery, the inverter, and the alternating current motor. The following describes, with reference to FIG. 1 and FIG. 2, a heating circuit of a power battery provided in the embodiments of the present disclosure.

The power battery includes a first battery core group 1 and a second battery core group 2 connected in series. The heating circuit includes an inverter 3, an alternating current motor 4, and a first controller 6.

The alternating current motor 4 is star-connected. Three tail ends of three phase coils (a coil A, a coil B, and a coil C) are connected together as a common end, such as a neutral point P2. The neutral point P2 of the alternating current motor 4 is connected to a first connection point P1. The first connection point P1 is a connection point between the first battery core group 1 and the second battery core group 2. In an embodiment, a battery pack includes the first battery core group and the second battery core group. The battery pack provides a main positive port, a main negative port, and a third port lead out of the first connection point P1 to the outside. The first connection point P1 is connected to the neutral point P2 of the alternating current motor 4 through the third port. In an embodiment, the first battery core group 1 and the second battery core group 2 are different battery packs.

The first controller is configured to input a driving signal to the inverter 3 to control the inverter 3 to alternately conduct the first battery core group 1 and the second battery core group 2 to the alternating current motor 4, to cause the first battery core group and the second battery core group to alternately charge each other.

In an embodiment, referring to FIG. 1 and FIG. 2, the inverter 3 includes an insulated gate bipolar transistor (IGBT) transistor T1, an IGBT transistor T2, an IGBT transistor T3, an IGBT transistor T4, an IGBT transistor T5, and an IGBT transistor T6. The IGBT transistors T1 to T6 include three bridge arms. An IGBT is a composite voltage-driven power semiconductor device including a bipolar junction transistor (BJT) and a Metal-Oxide-Semiconductor Field Effect Transistor (MOSFET), and has advantages of a high input impedance of a metal-oxide-semiconductor field-effect transistor (MOSFET) and a low conduction voltage drop of a giant transistor (GTR). Referring to FIG. 2, in the inverter 3, each IGBT transistor is further connected with a diode in parallel reversely. The diode can protect the circuit. In another embodiment, the IGBT transistors T1 to T6 may be respectively replaced with MOS transistors.

In an embodiment of the present disclosure, the IGBT transistor may output current signals of different frequencies and amplitudes in real time according to a frequency and a cycle of the driving signal. In an embodiment, the driving signal outputted by the first controller is a pulse width modulation (PWM) driving signal, that is, a pulse wave signal with a variable duty cycle.

In an embodiment of the present disclosure, referring to FIG. 2, the first controller outputs six driving signals Q1 to Q6. The driving signal Q1 is applied to the IGBT transistor T1, the driving signal Q2 is applied to the IGBT transistor T2, the driving signal Q3 is applied to the IGBT transistor T3, the driving signal Q4 is applied to the IGBT transistor T4, the driving signal Q5 is applied to the IGBT transistor T5, and the driving signal Q6 is applied to the IGBT transistor T6. The first controller alternately closes circuits from the first battery core group 1 and the second battery core group 2 to the alternating current motor 4 by respectively applying the driving signals Q1 to Q6 to the IGBT transistors T1 to T6, to cause the first battery core group 1 and the second battery core group 2 to alternately charge each other. In an embodiment, the first battery core group 1 discharges, the inverter 3 converts a direct current outputted by the first battery core group 1 into an alternating current and inputs the alternating current to the alternating current motor 4, and the alternating current motor 4 stores electric energy in a coil to charge the second battery core group 2. Then, the second battery core group 2 discharges, the inverter 3 converts a direct current outputted by the second battery core group 2 into an alternating current and inputs the alternating current to the alternating current motor 4, and the alternating current motor 4 stores the electric energy in the coil to charge the first battery core group 1. Through cyclical repetition of this process, the first battery core group and the second battery core group alternately charge each other.

In an embodiment, a switch 5 is connected in series between the neutral point P2 of the alternating current motor and the first connection point P1. The heating circuit further includes a second controller 7. The second controller is configured to control an on-off state of the switch 5, so that the switch 5 is turned on when the power battery needs to be heated and is turned off when the power battery does not need to be heated, to ensure the safety of a vehicle and the power battery. For example, the second controller controls the switch 5 to be turned off in a traveling state of an electric vehicle, to ensure the safety of traveling of the vehicle.

In an embodiment, a protection circuit 8, for example, a fuse, is connected in series between the neutral point P2 of the alternating current motor and the first connection point P1, to improve the safety of the battery heating process.

In an embodiment, a battery capacity of the first battery core group is the same as a battery capacity of the second battery core group. The arrangement of the first battery core group and the second battery core group having the same battery capacity facilitates simplification of a control logic algorithm and selection of related components of the heating circuit.

According to the heating circuit of the power battery provided in the embodiments of the present disclosure, a circuit is added based on an original circuit topology structure of the electric vehicle. The circuit is from the neutral point of the alternating current motor to the connection point between the first battery core group and the second battery core group. A change to an original circuit is small, and the solution is simple and easy to implement.

During heating of the power battery, a frequency and a magnitude of a charge/discharge current, that is, an excitation current, are limited by the related components. The heating circuit provided in the embodiments of the present disclosure enables a degree of limitation on the excitation current to be relatively small, making it possible to heat a battery with a relatively large excitation current. For example, if a limitation of a single coil of a motor on the excitation current is considered, assuming that an allowed maximum current value passing the single coil of the motor is 100 units, according to the heating circuit provided in the embodiments of the present disclosure, three coils simultaneously store energy and discharge, so that an upper limit of the excitation current may be 300 units.

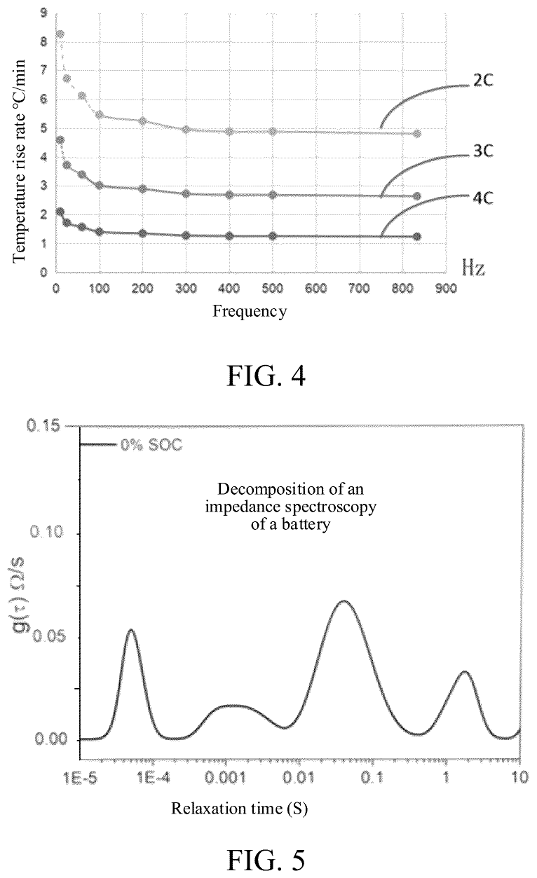

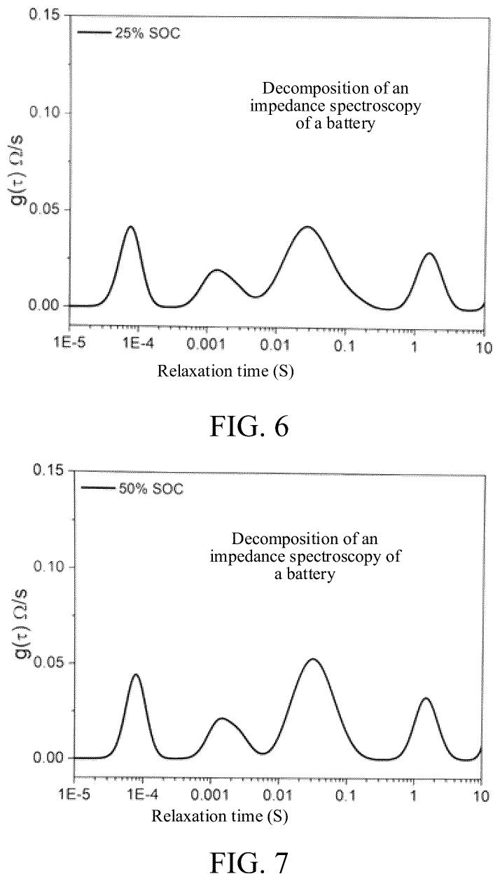

During heating of the power battery, control of the excitation current is important. Under the action of the relatively large excitation current, a temperature rise rate of the power battery is relatively fast. FIG. 3 shows a capacity retention rate of lithium iron phosphate with a ternary battery under a self-heating condition. At a temperature of −20° C., the power battery is heated by using an excitation current of 1 C, and a capacity retention rate is 99.0% to 99.94% after the power battery is heated for a preset quantity of times. In other words, a battery capacity is 99.0% to 99.94% of an original battery capacity after the power battery is heated for the preset quantity of times. 1 C is a current intensity when the battery fully discharges for one hour. The preset quantity of times is 200. For a case in which the power battery is heated by using a charge/discharge current of 2 C to 5 C, reference may also be made to FIG. 4. In other words, as the excitation current increases, adverse impact on the battery capacity also increases.

A high frequency of the excitation current affects heating efficiency, causing a temperature of the battery to rise slowly. This is due to inherent electrochemical characteristics of the battery. An impedance of the battery is larger under a low frequency current oscillation, and therefore a temperature rise effect is higher. However, during heating in a low temperature environment, low frequency excitation may lead to reduction of battery life and may even cause lithium precipitation. Referring to FIG. 3, the power battery is heated by using an excitation current of 2 C, an excitation current of 3 C, and an excitation current of 4 C separately, and a frequency of the excitation current is set to vary from 1 Hz to 1000 Hz. It can be learned that a temperature rise rate is higher in a low frequency stage, and especially in an interval of 1 Hz to 100 Hz.

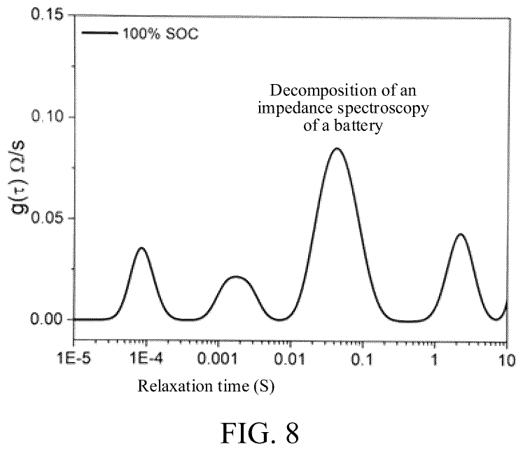

FIG. 5 to FIG. 8 are schematic diagrams of decomposition of a battery impedance spectroscopy of a power battery in different SOCs under the action of excitation currents of different frequencies. A state of charge (SOC) is the remaining charge in the battery and is usually expressed as a percentage, that is, a percentage of the remaining quantity of electricity of the battery to a total capacity of the battery. A horizontal axis is a periodicity length of an excitation current in units of seconds, a reciprocal thereof is a frequency of the excitation current, and the frequency gradually decreases from left to right in a direction of the horizontal axis. A vertical axis is distribution of an impedance over time in units of ohms per second. It can be learned from FIG. 5 to FIG. 8 that, in different SOCs, when a periodicity of the excitation current is in an interval of 0.01 s to 0.1 s (a frequency is in a range from 10 Hz to 100 Hz), there is a large peak in the distribution of the impedance over time. It can be learned from FIG. 5 to FIG. 8 that, in different SOCs, when the periodicity of the excitation current exceeds is (the frequency is less than 1 Hz), a relatively high lithium precipitation risk occurs.

In an embodiment of the present disclosure, the first controller obtains a battery status (a temperature, a quantity of electricity, or a voltage detected by sensors) and a magnitude and a frequency of a charge/discharge current that are monitored by a vehicle measurement system, and dynamically adjusts the frequency or the current magnitude of the excitation current in real time according to a preset policy. The following describes a manner of controlling the excitation current, that is, the charge/discharge current, in the embodiments.

In an embodiment of the present disclosure, a real-time current of the first battery core group 1 is denoted as I_{A}, and a real-time current of the second battery core group 2 is denoted as I_{B}. That I_{A} flows out of a positive electrode of the first battery core group 1 is denoted as a positive cycle, and that I_{A} flows into the positive electrode of the first battery core group 1 is denoted as a negative cycle. That I_{B} flows out of a positive electrode of the second battery core group 2 is denoted as a positive cycle, and that I_{B} flows into the positive electrode of the second battery core group 2 is denoted as a negative cycle.

Policy 1: The first controller is further configured to adjust the driving signal, to cause an average current intensity value of the first battery core group to be in a range from 1 C to 5 C and an average current intensity value of the second battery core group to be in a range from 1 C to 5 C within a first time period, and the first time period is 60 s. In other words, during heating of the power battery, within a time length of at least 60 s, the average current intensity value of the first battery core group is in the range from 1 C to 5 C, and the average current intensity value of the second battery core group is in the range from 1 C to 5 C.

An average current intensity value of a battery core group may be calculated through the following formula:

$${I}_{eff} = \frac{{\int }_{0}^{t} idt}{t} .$$

i is a magnitude of a real-time current of the battery core group (without considering a direction), that is, i is a positive value, t is time, and I_{eff} is the average current intensity value.

Herein, “C” is a rate of a magnitude of the charge/discharge current of the battery, and 1 C represents a current intensity when the battery fully discharges for one hour. For the first battery core group, 1 C=CA/3600 s, and CA is a rated capacity of the first battery core group in units of ampere hours. For the second battery core group, 1 C=CB/3600 s, and CB is a rated capacity of the second battery core group in units of ampere hours. In other words,

$$1 * ( CA / 3600 s ) \leq {I}_{effA} \leq 5 * ( CA / 3600 s )$$

$$1 * ( CB / 3600 s ) \leq {I}_{effB} \leq 5 * ( CA / 3600 s )$$

I_{effA} is the average current intensity value of the first battery core group 1 within the first time period, and I_{effB} is the average current intensity value of the second battery core group 2 within the first time period.

In the embodiments of the present disclosure, the excitation current is controlled to be in a range from 1 C to 5 C, so that heating efficiency can be ensured, and the adverse impact on the battery capacity is controlled within a small range. In addition, over-charge or over-discharge occurring on a battery core in the low temperature environment can be further avoided, thereby ensuring the safety of the battery core.

### Policy 2:

In an embodiment, the first controller is further configured to adjust the driving signal, to cause a quantity of times that a real-time current of the first battery core group is switched from a positive cycle to a negative cycle to be in a range from 1 to 1000 times within 1s and a quantity of times that a real-time current of the second battery core group is switched from a positive cycle to a negative cycle to be in a range from 1 to 1000 times within 1s. In other words, during heating of the power battery, a quantity of times that a real-time current of a battery core group is switched from the positive cycle to the negative cycle is in the range from 1 to 1000 times within a time length of is.

In an embodiment, the first controller is further configured to adjust the driving signal, to cause a quantity of times that a real-time current of the first battery core group is switched from a positive cycle to a negative cycle to be in a range from 5 to 1000 times within 1s and a quantity of times that a real-time current of the second battery core group is switched from a positive cycle to a negative cycle to be in a range from 5 to 1000 times within 1s. In other words, during heating of the power battery, a quantity of times that a real-time current of a battery core group is switched from the positive cycle to the negative cycle is in the range from 5 to 1000 times within a time length of 1 s.

In an embodiment, the first controller is further configured to adjust the driving signal, to cause a quantity of times that a real-time current of the first battery core group is switched from a positive cycle to a negative cycle to be in a range from 1 to 100 times within 1s and a quantity of times that a real-time current of the second battery core group is switched from a positive cycle to a negative cycle to be in a range from 1 to 100 times within 1s. In other words, during heating of the power battery, a quantity of times that a real-time current of a battery core group is switched from the positive cycle to the negative cycle is in the range from 1 to 100 times within a time length of is.

In an embodiment, the first controller is further configured to adjust the driving signal, to cause a quantity of times that a real-time current of the first battery core group is switched from a positive cycle to a negative cycle to be in a range from 5 to 100 times within 1s and a quantity of times that a real-time current of the second battery core group is switched from a positive cycle to a negative cycle to be in a range from 5 to 100 times within 1s. In other words, during heating of the power battery, a quantity of times that a real-time current of a battery core group is switched from the positive cycle to the negative cycle is in the range from 5 to 100 times within a time length of 1 s.

In an embodiment, the first controller is further configured to adjust the driving signal, to cause a quantity of times that a real-time current of the first battery core group is switched from a positive cycle to a negative cycle to be up to 10 times within 1s and a quantity of times that a real-time current of the second battery core group is switched from a positive cycle to a negative cycle to be up to 10 times within 1 s. In other words, during heating of the power battery, a quantity of times that a real-time current of a battery core group is switched from the positive cycle to the negative cycle is up to 10 times within a time length of 1s.

With reference to the content shown in FIG. 4 and FIG. 5 to FIG. 8, considering the adverse impact on the battery life and the lithium precipitation risk occurring on the excitation current in a low frequency, in the embodiments of the present disclosure, a range of a safety frequency of the excitation current is set to 1 Hz or more, that is, a lower limit of the frequency of the excitation current is 1 Hz. Considering the heating efficiency, an upper limit of the frequency of the excitation current is set to 1000 Hz. In the embodiments of the present disclosure, several ranges are preferably selected from a range from 1 Hz to 1000 Hz. The quantity of times that the real-time current of the battery core group is switched from the positive cycle to the negative cycle within unit time is set in the foregoing manner, so that the heating efficiency can be taken into account, impact of heating on the battery life can be reduced, and a risk in a heating process can be reduced.

Policy 3: The first controller is further configured to adjust the driving signal, to cause a magnitude of a real-time current of the first battery core group to be the same as a magnitude of a real-time current of the second battery core group. That is, in a heating process, within at least a period of time, |I_{A}|=|I_{B}|. “| |” is a symbol of an absolute value.

The magnitude of the real-time current of the first battery core group is the same as the magnitude of the real-time current of the second battery core group, which facilitates simplification of a control logic algorithm and selection of related components of the heating circuit and can reduce costs.

### Policy 4:

The first controller is further configured to adjust the driving signal, to cause a target ratio to be greater than or equal to 0.3. The target ratio is a ratio of a first value to a second value, the first value is a smaller one of a real-time current absolute value of the first battery core group and a real-time current absolute value of the second battery core group, and the second value is a larger one of the real-time current absolute value of the first battery core group and the real-time current absolute value of the second battery core group.

It can be learned from the policy 4 that, the magnitude of the real-time current of the first battery core group and the magnitude of the real-time current of the second battery core group may be different based on the heating circuit provided in the embodiments of the present disclosure. The ratio of the smaller one of the real-time current absolute value of the first battery core group and the real-time current absolute value of the second battery core group to the larger one of the real-time current absolute value of the first battery core group and the real-time current absolute value of the second battery core group is controlled to be 0.3 or more, so that the magnitude of the real-time current of the first battery core group and the magnitude of the real-time current of the second battery core group do not differ excessively. In this way, heating of the power battery can be well and easy implemented.

In the embodiments of the present disclosure, the foregoing policies may be superimposed to implement without conflict, to achieve a better effect.

In an embodiment of the present disclosure, the first controller may adjust a duty cycle and/or a frequency of the driving signal, to implement the foregoing control policies. For example, the first controller adjusts the duty cycle of the driving signal, to adjust the magnitude of the excitation current. For example, the first controller adjusts the frequency of the driving signal, to control a quantity of times that the excitation current is switched from the positive cycle to the negative cycle within a period of time.

In the embodiments of the present disclosure, through the foregoing policies, temperature rise efficiency and safety in a self-heating process are taken into account, the power battery can be heated efficiently without causing a large damage to the battery life, and the safety of the battery is ensured.

A first controller in an embodiment of the present disclosure may include a processor, a memory, and programs or instructions stored in the memory and executable on the processor, where the programs or the instructions are executed by the processor to implement the heating control policy according to any one of the foregoing embodiments.

An embodiment of the present disclosure provides a vehicle, including a power battery and the heating circuit of the power battery according to any one of the foregoing embodiments.

The embodiments of the present disclosure are all described in a progressive manner. For same or similar parts in the embodiments, reference may be made to these embodiments. Each embodiment focuses on a difference from other embodiments. For the electric vehicle embodiments, reference may be made to partial description in the method embodiments.

Embodiments of this specification are described above. Other embodiments fall within the scope of the appended claims. In some cases, the actions or steps recorded in the claims may be performed in sequences different from those in the embodiments and an expected result may still be achieved. In addition, the processes depicted in the accompanying drawings are not necessarily performed in the specific order or successively to achieve an expected result. In some implementations, multitasking and parallel processing may be feasible or beneficial.

The embodiments of this specification may be a system, a method, and/or a computer program product. The computer program product may include a non-transitory computer-readable storage medium, having computer instructions used for causing the processor to implement the aspects of the embodiments of this specification stored therein.

The non-transitory computer-readable storage medium may be a physical device that can retain and store computer instructions used by a computer instruction-executing device. The non-transitory computer-readable storage medium may be, for example, but is not limited to, an electrical storage device, a magnetic storage device, an optical storage device, an electromagnetic storage device, a semiconductor storage device, or any appropriate combination of the above. For example, the non-transitory computer-readable storage medium includes a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical coding device such as a punched card or protrusion in a groove in which computer instructions are stored, and any appropriate combination of the above. The non-transitory computer-readable storage medium as used here is not explained as a transient signal itself, such as a radio wave or other electromagnetic waves propagated freely, an electromagnetic wave propagated through a waveguide or other transmission media (e.g., a light pulse propagated through an optical fiber cable), or an electrical signal transmitted over a wire.

The computer instructions described herein may be downloaded to various computing/processing devices from the non-transitory computer-readable storage medium or may be downloaded to an external computer or an external storage device through a network such as an Internet, a local area network, a wide area network, and/or a wireless network. The network may include copper transmission cables, optical fiber transmission fibers, wireless transmission, routers, firewalls, switches, gateway computers, and/or edge servers. A network adapter card or network interface in each computing/processing device receives computer instructions from the network and forwards the computer instructions for storage in a computer-readable storage medium in each computing/processing device.

The flowcharts and block diagrams in the accompanying drawings illustrate architectures, functions, and operations that may be implemented for systems, methods and computer program products according to a plurality of embodiments of this specification. In this regard, each box in a flowchart or a block diagram may represent a module, a program segment or a part of computer instruction. The module, the program segment or the part of computer instruction includes one or more executable computer instructions used for implementing specified logic functions. In some implementations used as substitutes, functions annotated in boxes may occur in a sequence different from that annotated in an accompanying drawing. For example, actually two continuous boxes shown in succession may be performed basically in parallel, and sometimes the two boxes may be performed in a reverse sequence. This is determined by a related function. Each box in a block diagram and/or a flowchart and a combination of boxes in the block diagram and/or the flowchart may be implemented by using a dedicated hardware-based system configured to perform a specified function or action, or may be implemented by using a combination of dedicated hardware and a computer instruction. It is well known to a person skilled in the art that an implementation in hardware, an implementation in software, and an implementation in a combination of software and hardware are equivalent.

The embodiments of this specification are described above, and the foregoing descriptions are examples but not exhaustive and are not limited to the disclosed embodiments. Without departing from the scope of the described embodiments, many modifications and variations are apparent to a person of ordinary skill in the technical field. The selected terms used herein is to best explain the principles of the embodiments, practical applications, or improvements of technologies in the market, or to enable other persons of ordinary skill in the technical field to understand the embodiments disclosed herein.

What is claimed is:

1. A heating circuit of a power battery, wherein:
the power battery comprises a first battery core group and a second battery core group connected in series;
the heating circuit comprises an inverter, an alternating current motor, and a first controller;
a neutral point of the alternating current motor is connected to a first connection point between the first battery core group and the second battery core group; and
the first controller is configured to input a driving signal to control the inverter to alternately connect the first battery core group to the alternating current motor and the second battery core group to the alternating current motor, to cause the first battery core group and the second battery core group to charge each other.

2. The heating circuit according to claim 1, wherein a switch is connected in series between the neutral point of the alternating current motor and the first connection point, the heating circuit further comprises a second controller, and the second controller is configured to control the switch to turn on or off.

3. The heating circuit according to claim 1, wherein a protection circuit is connected in series between the neutral point of the alternating current motor and the first connection point.

4. The heating circuit according to claim 1, wherein a battery capacity of the first battery core group is the same as a battery capacity of the second battery core group.

5. The heating circuit according to claim 1, wherein the first controller is further configured to adjust the driving signal, to cause, within a first time period, an average current intensity value of the first battery core group to be in a range from 1 C to 5 C and an average current intensity value of the second battery core group to be in a range from 1 C to 5 C, 1 C is a current intensity when the battery fully discharges for one hour.

6. The heating circuit according to claim 1, wherein the first controller is further configured to adjust the driving signal, to cause that a real-time current of the first battery core group is switched from a positive cycle to a negative cycle to be in a range from 1 to 1000 times within 1 second and that a real-time current of the second battery core group is switched from a positive cycle to a negative cycle to be in a range from 1 to 1000 times within 1 second.

7. The heating circuit according to claim 1, wherein the first controller is further configured to adjust the driving signal, to cause that a real-time current of the first battery core group is switched from a positive cycle to a negative cycle to be in a range from 1 to 100 times within 1 second and that a real-time current of the second battery core group is switched from a positive cycle to a negative cycle to be in a range from 1 to 100 times within 1 second.

8. The heating circuit according to claim 1, wherein the first controller is further configured to adjust the driving signal, to cause that a real-time current of the first battery core group is switched from a positive cycle to a negative cycle to be up to 10 times within 1 second and that a real-time current of the second battery core group is switched from a positive cycle to a negative cycle to be up to 10 times within 1 second.

9. The heating circuit according to claim 1, wherein the first controller is further configured to adjust the driving signal, to cause a magnitude of a real-time current of the first battery core group to be the same as a magnitude of a real-time current of the second battery core group.

10. The heating circuit according to claim 1, wherein the first controller is further configured to adjust the driving signal, to cause a target ratio to be greater than or equal to 0.3, the target ratio is a ratio of a first value to a second value, the first value is a smaller one of a real-time current absolute value of the first battery core group and a real-time current absolute value of the second battery core group, and the second value is a larger one of the real-time current absolute value of the first battery core group and the real-time current absolute value of the second battery core group.

11. The heating circuit according to claim 5, wherein the first controller is configured to adjust the driving signal by adjusting a duty cycle and/or a frequency of the driving signal.

12. An electric vehicle, comprising a power battery and a heating circuit,
the power battery comprising a first battery core group and a second battery core group connected in series, and the heating circuit comprising an inverter, an alternating current motor, and a first controller;
a neutral point of the alternating current motor connected to a first connection point between the first battery core group and the second battery core group; and
the first controller configured to input a driving signal to control the inverter to alternately connect the first battery core group to the alternating current motor and the second battery core group to the alternating current motor, to cause the first battery core group and the second battery core group to charge each other.

13. The electric vehicle according to claim 12, wherein a switch is connected in series between the neutral point of the alternating current motor and the first connection point, the heating circuit further comprises a second controller, and the second controller is configured to control the switch to turn on or off.

14. The electric vehicle according to claim 12, wherein a protection circuit is connected in series between the neutral point of the alternating current motor and the first connection point.

15. The electric vehicle according to claim 12, wherein the first controller is further configured to adjust the driving signal, to cause, within a first time period, an average a current intensity value of the first battery core group to be in a range from 1 C to 5 C and an average current intensity value of the second battery core group to be in a range from 1 C to 5 C.

16. The electric vehicle according to claim 12, wherein the first controller is further configured to adjust the driving signal, to cause that a real-time current of the first battery core group is switched from a positive cycle to a negative cycle to be in a range from 1 to 1000 times within 1 second and that a real-time current of the second battery core group is switched from a positive cycle to a negative cycle to be in a range from 1 to 1000 times within 1 second.

17. The electric vehicle according to claim 12, wherein the first controller is further configured to adjust the driving signal, to cause that a real-time current of the first battery core group is switched from a positive cycle to a negative cycle to be in a range from 1 to 100 times within 1 second and that a real-time current of the second battery core group is switched from a positive cycle to a negative cycle to be in a range from 1 to 100 times within 1 second.

18. The electric vehicle according to claim 12, wherein the first controller is further configured to adjust the driving signal, to cause that a real-time current of the first battery core group is switched from a positive cycle to a negative cycle to be up to 10 times within 1 second and that a real-time current of the second battery core group is switched from a positive cycle to a negative cycle to be up to 10 times within 1 second.

19. The electric vehicle according to claim 12, wherein the first controller is further configured to adjust the driving signal, to cause a magnitude of a real-time current of the first battery core group to be the same as a magnitude of a real-time current of the second battery core group.

20. The electric vehicle according to claim 12, wherein the first controller is further configured to adjust the driving signal, to cause a target ratio to be greater than or equal to 0.3, the target ratio is a ratio of a first value to a second value, the first value is a smaller one of a real-time current absolute value of the first battery core group and a real-time current absolute value of the second battery core group, and the second value is a larger one of the real-time current absolute value of the first battery core group and the real-time current absolute value of the second battery core group.
